(19) United States
(12) Patent Application Publication
(10) Pub. No.: US 2016/0373828 A1
(43) Pub. Date: Dec. 22, 2016

(54) DISPLAY DEVICE AND OPERATING METHOD THEREOF

(71) Applicant: LG ELECTRONICS INC., Seoul (KR)

(72) Inventors: Seongwoon SEOL, Seoul (KR); Eunyoung CHO, Seoul (KR); Kwanhee SEO, Seoul (KR); Jeonghwan HWANG, Seoul (KR); Sangjin AHN, Seoul (KR)

(73) Assignee: LG ELECTRONICS INC., Seoul (KR)

(21) Appl. No.: 15/184,620

(22) Filed: Jun. 16, 2016

(30) Foreign Application Priority Data
Jun. 17, 2015 (KR) 10-2015-0085633
Jun. 7, 2016 (KR) 10-2016-0070148

(51) Int. Cl. H04N 21/485; H04N 21/431; H04N 21/61

(52) U.S. Cl. CPC H04N 21/4858; H04N 21/6125; H04N 21/4312

(57) ABSTRACT

A display device includes a display unit for displaying a first video, a controller for receiving a zoom control command for the first video and controlling a second video on which zoom control is performed to be displayed on the display unit according to the received zoom control command, and a storage unit for storing zoom data on the basis of the received zoom control command and a thumbnail image corresponding to the second video, wherein, as a command for selecting the thumbnail image corresponding to the second video is received, the controller controls the second video to be displayed by processing together the first video and the zoom data.

### CROSS-REFERENCE TO RELATED APPLICATIONS

Pursuant to 35 U.S.C. §119(a), this application claims the benefits of earlier filing date and right of priority to Korean Patent Application No. 10-2015-0085633, filed on Jun. 17, 2015 and Korean Patent Application No. 10-2016-0070148, filed on Jun. 7, 2016, the contents of which are all hereby incorporated by reference herein in its entirety.

### BACKGROUND

The present invention relates to a display device and an operating method thereof.

Recently, digital TV services using wired or wireless communication networks have been generalized. The digital TV services can provide various services which have not been provided in the existing analog broadcasting services.

For example, an Internet protocol television (IPTV) service or a mart TV service, which is one type of the digital TV services, is a bidirectional service which allows a user to actively select the kind, viewing time, or the like of a program to be watched. The IPTV service or the smart TV service can provide various additional services, for example, Internet search, home shopping, on-line games, and the like, based on the bidirectional service capability.

Also, a live zoom function of enabling a user to enlarge/reduce and shift a desired portion and view the desired portion during playing of video has recently been provided. Therefore, when users view a certain video, each of the users may enlarge and view only a portion that the user desires to view. For example, only a specific singer may be enlarged in a video of a stage on which several singers give a performance, only a figure of a user's child may be enlarged in a video of a school arts festival, or only a scene in which a goal is scored may be enlarged in a soccer game.

However, there is an inconvenience in that, when a user desires to again view a video that was enlarged/reduced and shifted through the live zoom function, the user should again perform the same manipulation. That is, there may be an inconvenience in that, whenever the same video is played, the user should newly perform enlargement/reduction and shift on the video through the live zoom function.

### SUMMARY

Embodiments provide a method capable of producing several videos for only a user with respect to one video.

Embodiments also provide a display device capable of storing a live zoom manipulation history of a user during playing of video.

Embodiments also provide a display device capable of storing a live zoom manipulation history of a user as a file in a text format during playing of video.

Embodiments also provide a display device capable of displaying video in which a desired portion is enlarged without any manipulation, using a live zoom manipulation history.

In one embodiment, a display device includes: a display unit configured to display a first video; a controller configured to receive a zoom control command for the first video and control a second video on which zoom control is performed to be displayed on the display unit according to the received zoom control command; and a storage unit configured to store zoom data on the basis of the received zoom control command and a thumbnail image corresponding to the second video, wherein, as a command for selecting the thumbnail image corresponding to the second video is received, the controller controls the second video to be displayed by processing together the first video and the zoom data.

The zoom control command may include a magnification change command of a video and a position change command of the video.

The zoom data may include a play time of the video on which the zoom control is performed according to the zoom control command, a pointer position coordinate, and magnification information.

The zoom data may further include a storage position of the thumbnail image, and the thumbnail image may include an image at the moment when the zoom control is performed on the video according to the zoom control command.

The zoom data may be data stored in a text format.

When a zoom video storage command is received, the storage unit may store the zoom data on the basis of the received zoom control command and the thumbnail image corresponding to the second video.

The controller may recognize the received zoom control command as the zoom video storage command.

The storage unit may accumulate and store the zoom data on the basis of the zoom control command whenever the zoom control command is received.

The display unit may display a video list including a first video list and a second video list.

The controller may control an original video on which the zoom control is not performed to be displayed on the display unit if a command for selecting the first video list is received, and may control the second video to be displayed on the display unit by processing together the first video and the zoom data if a command for selecting the second video list is received.

The second video list may include a thumbnail image at the moment when the zoom control is performed as the zoom control command is received.

The display unit may further display a sub-screen when the second video is displayed, and the sub-screen may be a screen for displaying which portion the second video in the first video.

The display unit may further display a list of at least one zoom video related to the first video while the first video is being displayed.

The at least one zoom video related to the first video may include videos played by processing together the first video and previously stored zoom data.

The at least one zoom video related to the first video may include videos played by processing together the first video and zoom data received from an external server.

The details of one or more embodiments are set forth in the accompanying drawings and the description below. Other features will be apparent from the description and drawings, and from the claims.

### BRIEF DESCRIPTION OF THE DRAWINGS

FIG. 1 is a block diagram illustrating a configuration of a display device according to an embodiment of the present invention.

FIG. 2 is a block diagram illustrating a remote control device according to an embodiment of the present invention.

FIG. 3 is a view illustrating an actual configuration of a remote control device according to an embodiment of the present invention.

FIG. 4 is a view of utilizing a remote control device according to an embodiment of the present invention.

FIG. 5 is a flowchart illustrating a method for storing a personalized zoom video according to an embodiment of the present invention.

FIG. 6 is a view illustrating a personalized zoom video icon according to an embodiment of the present invention.

FIG. 7 is a view illustrating a personalized zoom video item according to an embodiment of the present invention.

FIG. 8 is a view illustrating an operation of receiving a personalized zoom video storage command according to an embodiment of the present invention.

FIG. 9 is a view illustrating a screen displayed on a display unit during storage of a personalized zoom video according to an embodiment of the present invention.

FIG. 10 is a view illustrating an example of zoom data according to an embodiment of the present invention.

FIG. 11 is an exemplary view illustrating a pointer position coordinate when a zoom control command is received using a pointer according to an embodiment of the present invention.

FIG. 12 is a view illustrating a method for storing zoom data in a storage unit according to an embodiment of the present invention.

FIG. 13 is a flowchart illustrating a method for loading a personalized zoom video according to an embodiment of the present invention.

FIG. 14 is a view illustrating a video list using thumbnail images according to an embodiment of the present invention.

FIG. 15 is a view illustrating a method for loading a personalized zoom video related to a video being played according to an embodiment of the present invention.

FIG. 16 is a view illustrating an original video displayed on the display unit according to an embodiment of the present invention.

FIG. 17 is a view illustrating a personalized zoom video displayed on the display unit according to a first embodiment of the present invention.

FIG. 18 is a view illustrating a personalized zoom video displayed on the display unit according to a second embodiment of the present invention.

### DETAILED DESCRIPTION OF THE EMBODIMENTS

Hereinafter, embodiments relating to the present invention will be described in detail with reference to the accompanying drawings. The suffixes “module” and “unit” for components used in the description below are assigned or mixed in consideration of easiness in writing the specification and do not have distinctive meanings or roles by themselves.

A display device according to an embodiment of the present invention, for example, as an artificial display device that adds a computer supporting function to a broadcast receiving function, can have an easy-to-use interface such as a writing input device, a touch screen, or a spatial remote controller as an internet function is added while fulfilling the broadcast receiving function. Then, with the support of a wired or wireless internet function, it is possible to perform an e-mail, web browsing, banking, or game function in access to internet and computers. In order for such various functions, standardized general purpose OS can be used.

Accordingly, since various applications are freely added or deleted on a general purpose OS kernel, a display device described in this present invention, for example, can perform various user-friendly functions. The display device, in more detail, can be network TV, HBBTV, smart TV, LED TV, OLED TV, and so on and in some cases, can be applied to a smartphone.

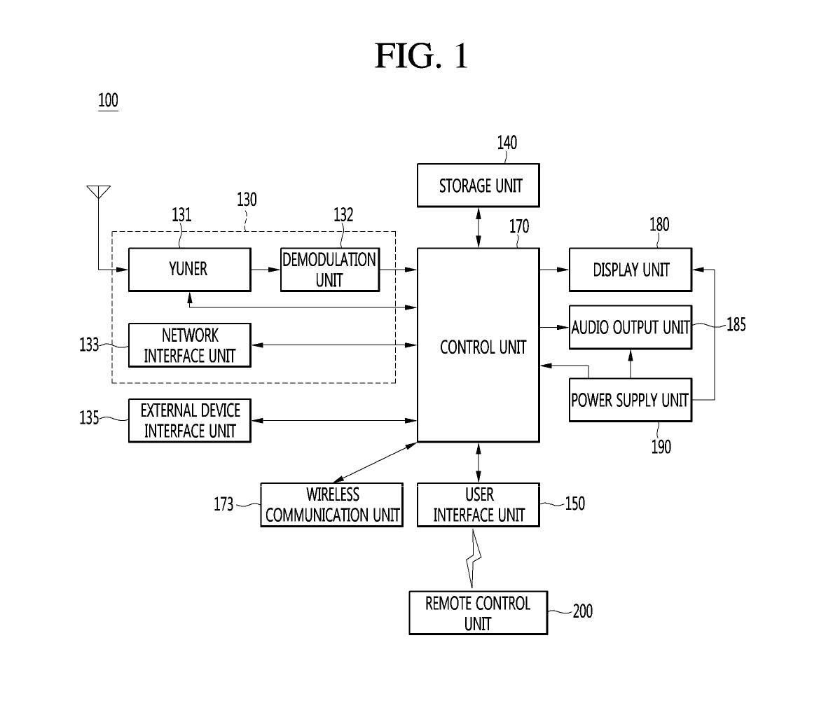

FIG. 1 is a block diagram illustrating a configuration of a display device according to an embodiment of the present invention.

Referring to FIG. 1, a display device 100 can include a broadcast reception unit 130, an external device interface unit 135, a storage unit 140, a user input interface unit 150, a control unit 170, a wireless communication unit 173, a display unit 180, an audio output unit 185, and a power supply unit 190.

The broadcast reception unit 130 can include a tuner 131, a demodulation unit 132, and a network interface unit 133.

The tuner 131 can select a specific broadcast channel according to a channel selection command. The tuner 131 can receive broadcast signals for the selected specific broadcast channel.

The demodulation unit 132 can divide the received broadcast signals into video signals, audio signals, and broadcast program related data signals and restore the divided video signals, audio signals, and data signals to an output available form.

The external device interface unit 135 can receive an application or an application list in an adjacent external device and deliver it to the control unit 170 or the storage unit 140.

The external device interface 135 can provide a connection path between the display device 100 and an external device. The external device interface 135 can receive at least one of image and audio output from an external device that is wirelessly or wiredly connected to the display device 100 and deliver it to the control unit. The external device interface unit 135 can include a plurality of external input terminals. The plurality of external input terminals can include an RGB terminal, at least one High Definition Multimedia Interface (HDMI) terminal, and a component terminal.

An image signal of an external device inputted through the external device interface unit 135 can be output through the display unit 180. A sound signal of an external device inputted through the external device interface unit 135 can be output through the audio output unit 185.

An external device connectable to the external device interface unit 130 can be one of a set-top box, a Blu-ray player, a DVD player, a game console, a sound bar, a smartphone, a PC, a USB Memory, and a home theater system but this is just exemplary.

The network interface unit 133 can provide an interface for connecting the display device 100 to a wired/wireless network including internet network. The network interface unit 133 can transmit or receive data to or from another user or another electronic device through an accessed network or another network linked to the accessed network.

Additionally, some content data stored in the display device 100 can be transmitted to a user or an electronic device, which is selected from other users or other electronic devices pre-registered in the display device 100.

The network interface unit 133 can access a predetermined webpage through an accessed network or another network linked to the accessed network. That is, it can transmit or receive data to or from a corresponding server by accessing a predetermined webpage through network.

Then, the network interface unit 133 can receive contents or data provided from a content provider or a network operator. That is, the network interface unit 133 can receive contents such as movies, advertisements, games, VODs, and broadcast signals, which are provided from a content provider or a network provider, through network and information relating thereto.

Additionally, the network interface unit 133 can receive firmware update information and update files provided from a network operator and transmit data to an internet or content provider or a network operator.

The network interface unit 133 can select and receive a desired application among applications open to the air, through network.

The storage unit 140 can store signal-processed image, voice, or data signals stored by a program in order for each signal processing and control in the control unit 170.

Additionally, the storage unit 140 can perform a function for temporarily store image, voice, or data signals output from the external device interface unit 135 or the network interface unit 133 and can store information on a predetermined image through a channel memory function.

The storage unit 140 can store an application or an application list inputted from the external device interface unit 135 or the network interface unit 133.

The display device 100 can play content files (for example, video files, still image files, music files, document files, application files, and so on) stored in the storage unit 140 and provide them to a user.

The user input interface unit 150 can deliver signals inputted from a user to the control unit 170 or deliver signals from the control unit 170 to a user. For example, the user input interface unit 150 can receive or process control signals such as power on/off, channel selection, and screen setting from the remote control device 200 or transmit control signals from the control unit 170 to the remote control device 200 according to various communication methods such as Bluetooth, Ultra Wideband (WB), ZigBee, Radio Frequency (RF), and IR.

Additionally, the user input interface unit 150 can deliver, to the control unit 170, control signals inputted from local keys (not shown) such as a power key, a channel key, a volume key, and a setting key.

Image signals that are image-processed in the control unit 170 can be inputted to the display unit 180 and displayed as an image corresponding to corresponding image signals. Additionally, image signals that are image-processed in the control unit 170 can be inputted to an external output device through the external device interface unit 135.

Voice signals processed in the control unit 170 can be output to the audio output unit 185. Additionally, voice signals processed in the control unit 170 can be inputted to an external output device through the external device interface unit 135.

Besides that, the control module 170 can control overall operations in the display device 100.

Additionally, the control unit 170 can control the display device 100 by a user command or internal program inputted through the user input interface unit 150 and download a desired application or application list into the display device 100 in access to network.

The control unit 170 can output channel information selected by a user together with processed image or voice signals through the display unit 180 or the audio output unit 185.

Additionally, according to an external device image playback command received through the user input interface unit 150, the control unit 170 can output image signals or voice signals of an external device such as a camera or a camcorder, which are inputted through the external device interface unit 135, through the display unit 180 or the audio output unit 185.

Moreover, the control unit 170 can control the display unit 180 to display images and control broadcast images inputted through the tuner 131, external input images inputted through the external device interface unit 135, images inputted through the network interface unit, or images stored in the storage unit 140 to be displayed on the display unit 180. In this case, an image displayed on the display unit 180 can be a still image or video and also can be a 2D image or a 3D image.

Additionally, the control unit 170 can play content stored in the display device 100, received broadcast content, and external input content inputted from the outside, and the content can be in various formats such as broadcast images, external input images, audio files, still images, accessed web screens, and document files.

Moreover, the wireless communication unit 173 can perform a wired or wireless communication with an external electronic device. The wireless communication unit 173 can perform short-range communication with an external device. For this, the wireless communication unit 173 can support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies. The wireless communication unit 173 can support wireless communication between the display device 100 and a wireless communication system, between the display device 100 and another display device 100, or between networks including the display device 100 and another display device 100 (or an external server) through wireless area networks. The wireless area networks can be wireless personal area networks.

Herein, the other display device 100 can be a mobile terminal such as a wearable device (for example, a smart watch, a smart glass, and a head mounted display (HMD)) or a smartphone, which is capable of exchanging data (or inter-working) with the display device 100. The wireless communication unit 173 can detect (or recognize) a communicable wearable device around the display device 100. Furthermore, if the detected wearable device is a device authenticated to communicate with the display device 100, the control unit 170 can transmit at least part of data processed in the display device 100 to the wearable device through the wireless communication unit 173. Accordingly, a user of the wearable device can use the data processed in the display device 100 through the wearable device.

The wireless communication unit 173 can be provided separated from the external device interface unit 135 and can be included in the external device interface unit 135.

The display unit 180 can convert image signals, data signals, or OSD signals, which are processed in the control unit 170, or images signals or data signals, which are received in the external device interface unit 135, into R, G, and B signals to generate driving signals.

Furthermore, the display device 100 shown in FIG. 1 is just one embodiment of the present invention and thus, some of the components shown can be integrated, added, or omitted according to the specification of the actually implemented display device 100.

That is, if necessary, two or more components can be integrated into one component or one component can be divided into two or more components and configured. Additionally, a function performed by each block is to describe an embodiment of the present invention and its specific operation or device does not limit the scope of the present invention.

According to another embodiment of the present invention, unlike FIG. 1, the display device 100 can receive images through the network interface unit 133 or the external device interface unit 135 and play them without including the tuner 131 and the demodulation unit 132.

For example, the display device 100 can be divided into an image processing device such as a set-top box for receiving broadcast signals or contents according to various network services and a content playback device for playing contents inputted from the image processing device.

In this case, an operating method of a display device according to an embodiment of the present invention described below can be performed by one of the display device described with reference to FIG. 1, an image processing device such as the separated set-top box, and a content playback device including the display unit 180 and the audio output unit 185.

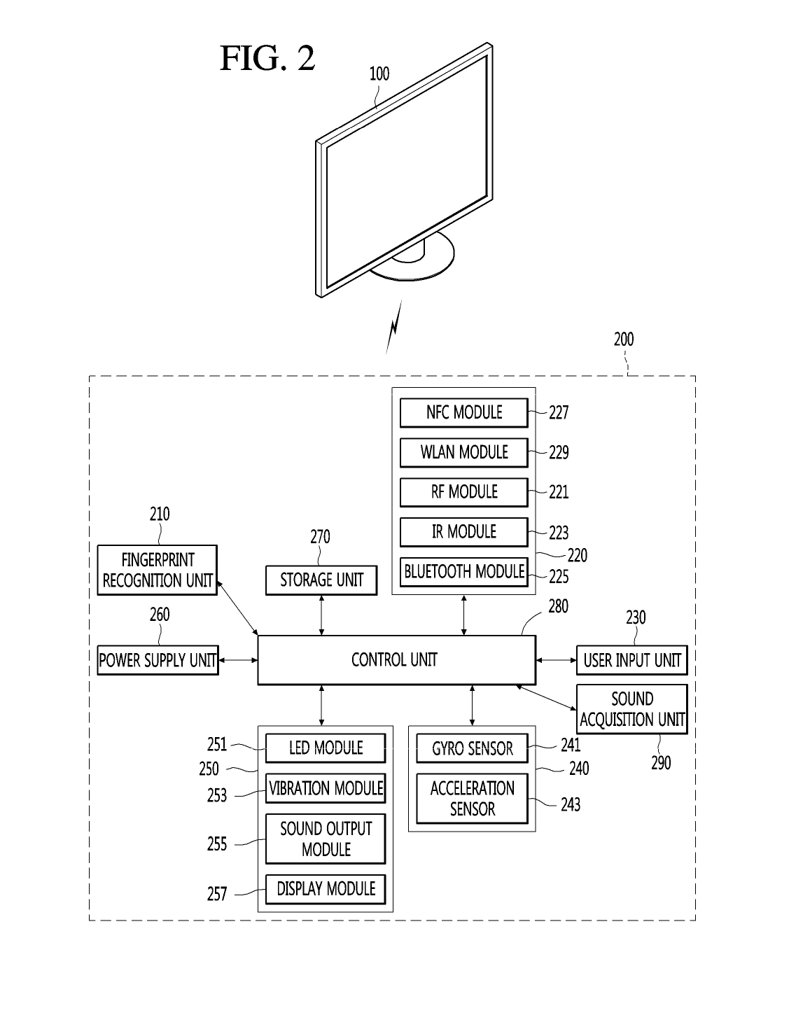

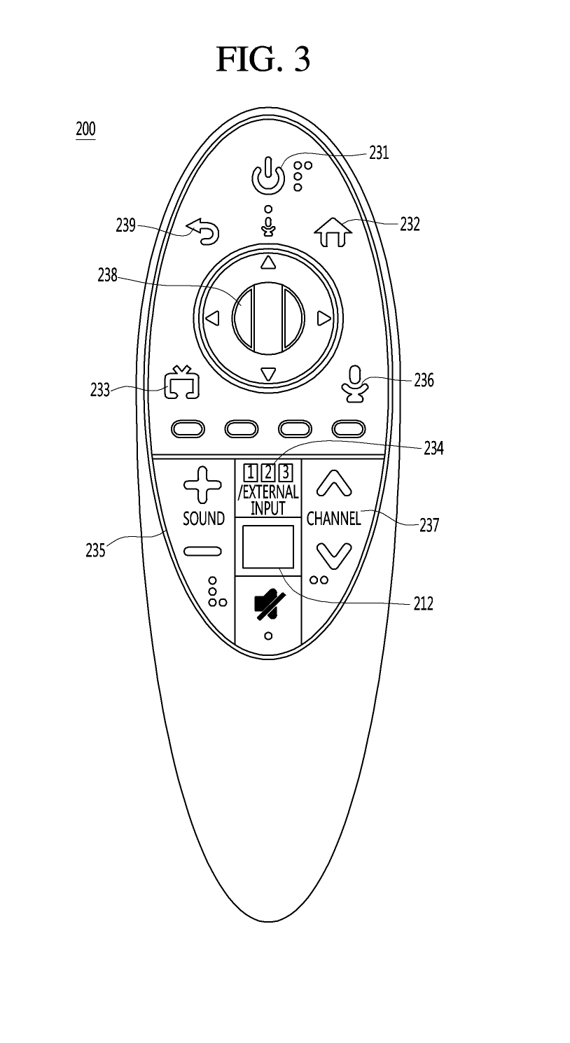

Then, referring to FIGS. 2 and 3, a remote control device is described according to an embodiment of the present invention.

FIG. 2 is a block diagram illustrating a remote control device according to an embodiment of the present invention and FIG. 3 is a view illustrating an actual configuration of a remote control device according to an embodiment of the present invention.

First, referring to FIG. 2, a remote control device 200 can include a fingerprint recognition unit 210, a wireless communication unit 220, a user input unit 230, a sensor unit 240, an output unit 250, a power supply unit 260, a storage unit 270, a control unit 280, and a voice acquisition unit 290.

Referring to FIG. 2, the wireless communication unit 225 transmits/receives signals to/from an arbitrary any one of display devices according to the above-mentioned embodiments of the present invention.

The remote control device 200 can include an RF module 221 for transmitting/receiving signals to/from the display device 100 according to the RF communication standards and an IR module 223 for transmitting/receiving signals to/from the display device 100 according to the IR communication standards. Additionally, the remote control device 200 can include a Bluetooth module 225 for transmitting/receiving signals to/from the display device 100 according to the Bluetooth communication standards. Additionally, the remote control device 200 can include an NFC module 227 for transmitting/receiving signals to/from the display device 100 according to the Near Field Communication (NFC) communication standards and a WLAN module 229 for transmitting/receiving signals to/from the display device 100 according to the Wireless LAN (WLAN) communication standards

Additionally, the remote control device 200 can transmit signals containing information on a movement of the remote control device 200 to the display device 100 through the wireless communication unit 220.

Moreover, the remote control device 200 can receive signals transmitted from the display device 100 through the RF module 221 and if necessary, can transmit a command on power on/off, channel change, and volume change to the display device 100 through the IR module 223.

The user input unit 230 can be configured with a keypad button, a touch pad, or a touch screen. A user can manipulate the user input unit 230 to input a command relating to the display device 100 to the remote control device 200. If the user input unit 230 includes a hard key button, a user can input a command relating to the display device 100 to the remote control device 200 through the push operation of the hard key button. This will be described with reference to FIG. 3.

Referring to FIG. 3, the remote control device 200 can include a plurality of buttons. The plurality of buttons can include a fingerprint recognition button 212, a power button 231, a home button 232, a live button 233, an external input button 234, a voice adjustment button 235, a voice recognition button 236, a channel change button 237, a check button 238, and a back button 239.

The fingerprint recognition button 212 can be a button for recognizing a user's fingerprint. According to an embodiment of the present invention, the fingerprint recognition button 212 can perform a push operation and receive a push operation and a fingerprint recognition operation. The power button 231 can be button for turning on/off the power of the display device 100. The power button 232 can be button for moving to the home screen of the display device 100. The live button 233 can be a button for displaying live broadcast programs. The external input button 234 can be button for receiving an external input connected to the display device 100. The voice adjustment button 235 can be button for adjusting the size of a volume output from the display device 100. The voice recognition button 236 can be a button for receiving user's voice and recognizing the received voice. The channel change button 237 can be a button for receiving broadcast signals of a specific broadcast channel. The check button 238 can be a button for selecting a specific function and the back button 239 can be a button for returning to a previous screen.

Again, FIG. 2 is described.

If the user input unit 230 includes a touch screen, a user can touch a soft key of the touch screen to input a command relating to the display device 100 to the remote control device 200. Additionally, the user input unit 230 can include various kinds of input means manipulated by a user, for example, a scroll key and a jog key, and this embodiment does not limit the scope of the present invention.

The sensor unit 240 can include a gyro sensor 241 or an acceleration sensor 243 and the gyro sensor 241 can sense information on a movement of the remote control device 200.

For example, the gyro sensor 241 can sense information on an operation of the remote control device 200 on the basis of x, y, and z axes and the acceleration sensor 243 can sense information on a movement speed of the remote control device 200. Moreover, the remote control device 200 can further include a distance measurement sensor and sense a distance with respect to the display unit 180 of the display device 100.

The output unit 250 can output image or voice signals corresponding to a manipulation of the user input unit 235 or corresponding to signals transmitted from the display device 100. A user can recognize whether the user input unit 235 is manipulated or the display device 100 is controlled through the output unit 250.

For example, the output unit 250 can include an LED module 251 for flashing, a vibration module 253 for generating vibration, a sound output module 255 for outputting sound, or a display module 257 for outputting an image, if the user input unit 235 is manipulated or signals are transmitted/received to/from the display device 100 through the wireless communication unit 225.

Additionally, the power supply unit 260 supplies power to the remote control device 200 and if the remote control device 200 does not move for a predetermined time, stops the power supply, so that power waste can be reduced. The power supply unit 260 can resume the power supply if a predetermined key provided at the remote control device 200 is manipulated.

The storage unit 270 can store various kinds of programs and application data necessary for a control or operation of the remote control device 200. If the remote control device 200 transmits/receives signals wirelessly through the display device 100 and the RF module 221, the remote control device 200 and the display device 100 transmits/receives signals through a predetermined frequency band.

The control unit 280 of the remote control device 200 can store, in the storage unit 270, information on a frequency band for transmitting/receiving signals to/from the display device 100 paired with the remote control device 200 and refer to it.

The control unit 280 controls general matters relating to a control of the remote control device 200. The control unit 280 can transmit a signal corresponding to a predetermined key manipulation of the user input unit 235 or a signal corresponding to a movement of the remote control device 200 sensed by the sensor unit 240 to the display device 100 through the wireless communication unit 225.

Additionally, the voice acquisition unit 290 of the remote control device 200 can obtain voice.

The voice acquisition unit 290 can include at least one microphone 291 and obtain voice through the microphone 291.

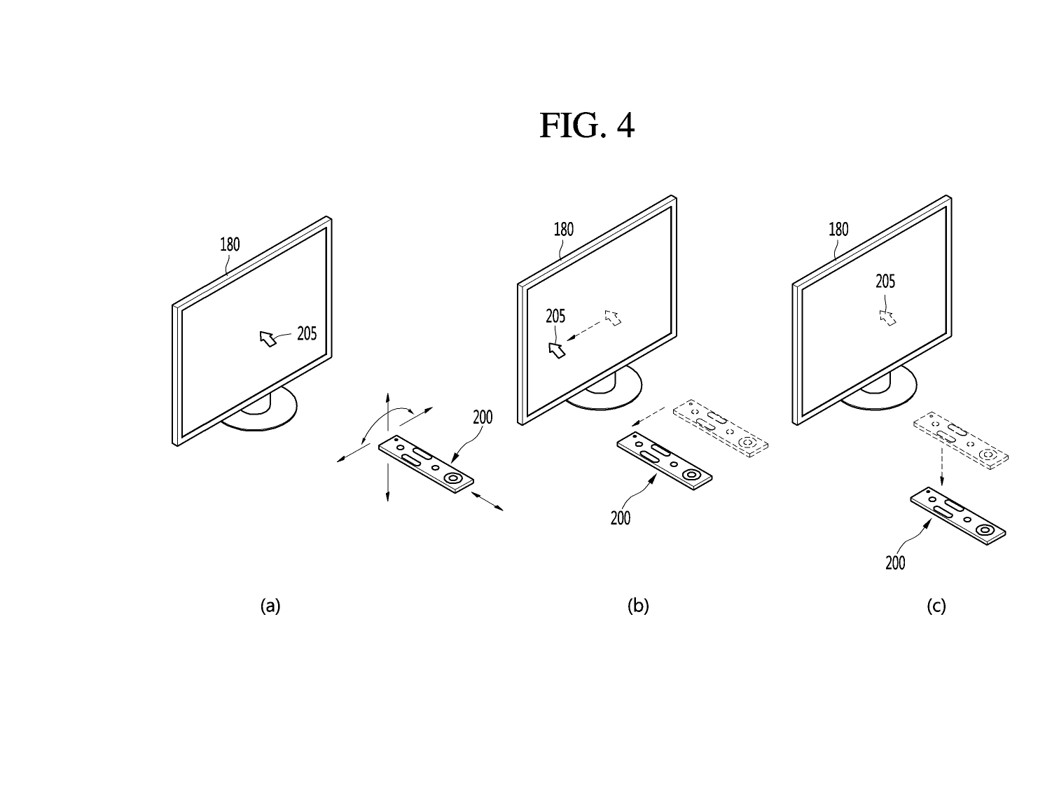

Then, FIG. 4 is described.

FIG. 4 is a view of utilizing a remote control device according to an embodiment of the present invention.

FIG. 4A illustrates that a pointer 205 corresponding to the remote control device 200 is displayed on the display unit 180.

A user can move or rotate the remote control device 200 vertically or horizontally. The pointer 205 displayed on the display unit 180 of the display device 100 corresponds to a movement of the remote control device 200. Since the corresponding pointer 205 is moved and displayed according to a movement on a 3D space as show in the drawing, the remote control device 200 can be referred to as a spatial remote controller.

FIG. 4B illustrates that if a user moves the remote control device 200, the pointer 205 displayed on the display unit 180 of the display device 100 is moved to the left in correspondence thereto.

Information on a movement of the remote control device 200 detected through a sensor of the remote control device 200 is transmitted to the display device 100. The display device 100 can calculate the coordinates of the pointer 205 from the information on the movement of the remote control device 200. The display device 100 can display the pointer 205 to match the calculated coordinates.

FIG. 4C illustrates that while a specific button in the remote control device 200 is pressed, a user moves the remote control device 200 away from the display unit 180. Thus, a selection area in the display unit 180 corresponding to the pointer 205 can be zoomed in and displayed largely.

On the other hand, if a user moves the remote control device 200 close to the display unit 180, a selection area in the display unit 180 corresponding to the pointer 205 can be zoomed out and displayed reduced.

On the other hand, if the remote control device 200 is away from the display unit 180, a selection area can be zoomed out and if the remote control device 200 is close to the display unit 180, a selection area can be zoomed in.

Additionally, if a specific button in the remote control device 200 is pressed, the recognition of a vertical or horizontal movement can be excluded. That is, if the remote control device 200 is moved away from or close to the display unit 180, the up, down, left, or right movement can not be recognized and only the back and fourth movement can be recognized. While a specific button in the remote control device 200 is not pressed, only the pointer 205 is moved according to the up, down, left or right movement of the remote control device 200.

Moreover, the moving speed or moving direction of the pointer 205 can correspond to the moving speed or moving direction of the remote control device 200.

Furthermore, a pointer in this specification means an object displayed on the display unit 180 in correspondence to an operation of the remote control device 200. Accordingly, besides an arrow form displayed as the pointer 205 in the drawing, various forms of objects are possible. For example, the above concept includes a point, a cursor, a prompt, and a thick outline. Then, the pointer 205 can be displayed in correspondence to one point of a horizontal axis and a vertical axis on the display unit 180 and also can be displayed in correspondence to a plurality of points such as a line and a surface.

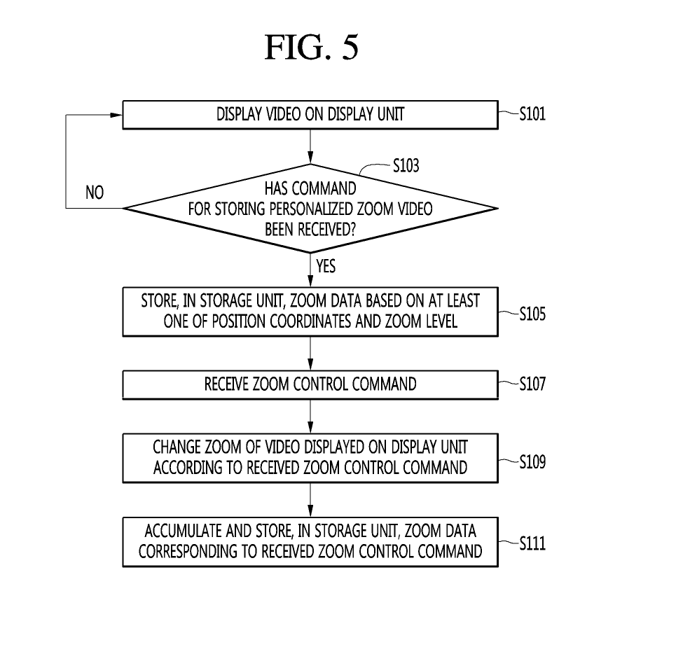

Next, a method for storing a personalized zoom video according to an embodiment of the present invention will be described with reference to FIG. 5.

First, a personalized zoom video will be described. The personalized zoom video may refer to a video played based on a stored (or set) enlargement and position manipulation history with respect to one video. Specifically, when a certain video is viewed, portions to be enlarged and viewed may be different for every user. For example, portions to be enlarged may be different for every user with respect to the same video, such as when only a specific singer is enlarged in a video of a stage on which several singers give a performance, when only a figure of a user's child is enlarged in a video of a school arts festival, or when only a scene in which a goal is scored is enlarged in a soccer game. Thus, a user can produce a video for only the user using a method for storing an enlargement and position manipulation history and playing video based on the stored enlargement and position manipulation history, using a live zoom function of enlarging video or manipulating a position of the video.

That is, the personalized zoom video may refer to a video for only a user, which is produced using the above-described method. The personalized zoom video may be created in a plurality of versions with respect to one video. As the personalized zoom video is stored, it is possible to reduce an inconvenience that, whenever the same video is viewed, a user is to repeatedly perform a command for manipulating a position of the video or changing a magnification of the video through the live zoom function.

FIG. 5 is a flowchart illustrating a method for storing a personalized zoom video according to an embodiment of the present invention.

The controller 170 may control a video to be displayed on the display unit 180 (S101).

The video displayed on the display unit 180 may correspond to any one of a broadcast video inputted through the tuner 131, a video inputted through the external device interface unit 135, a video inputted through the network interface unit 133, and a video stored in the storage unit 140.

Also, the video displayed on the display unit 180 may be an original video on which no zoom control is performed, or may be a video on which the zoom control has already been performed as a zoom control command was received.

The zoom control may include a control for enlarging or reducing a video and a control for changing a position of the enlarged or reduced video.

The controller 170 may control a video to be displayed on the display unit 180 as a command for pressing a button provided in the display device 100 is received. Alternatively, the controller 170 may control a video to be displayed on the display unit 180 as a command is received from a remote control device 200.

Next, the controller 170 may determine whether a command for storing a personalized zoom video has been received (S103).

According to an embodiment of the present invention, the controller 170 may receive a command for storing a personalized zoom video through a personalized zoom video storage icon displayed on the display unit 180.

According to another embodiment of the present invention, the controller 170 may recognize the zoom control command as a command for storing a personalized zoom video. For example, the controller 170 may control the personalized zoom video to operate in a storage mode as the zoom control command is received. A detailed description of the zoom control command will be described later.

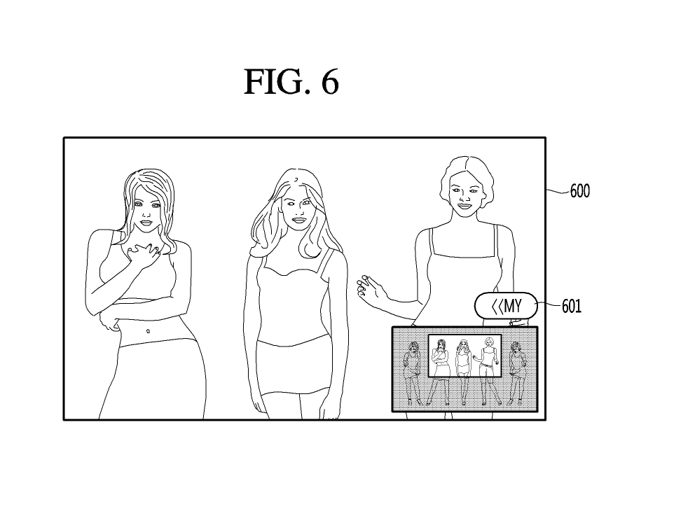

First, a method for receiving a command for storing a personalized zoom video through a personalized zoom video storage icon according to an embodiment of the present invention will be described with reference to FIGS. 6 to 8.

FIG. 6 is a view illustrating a personalized zoom video icon according to an embodiment of the present invention.

As shown in FIG. 6, according to the embodiment of the present invention, the display unit 180 may display a video 600. The video displayed on the display unit 180 may be a video on which no zoom control is performed, or may be a video on which the zoom control has been performed. In the present invention, a case where a zoomed video is displayed on the display unit 180 will be described as an example.

The controller 170 may control a personalized zoom video icon 601 to be further displayed together with the video 600 on the display unit 180. The personalized zoom video icon 601 may be displayed to overlap with the video 600 displayed on the display unit 180, or may be displayed at a position at which the personalized zoom video icon 601 does not overlap with the video 600 displayed on the display unit 180.

Also, the controller 170 may control the personalized zoom video icon 601 displayed on the display unit 180 to be disappeared, if any user input is not detected for a preset period of time. The controller 170 may control the personalized zoom video icon 601 to be again displayed on the display unit 180 as the user input is detected.

In this case, the user input may represent, for example, movement of a pointer (not shown) displayed on the display unit 180. Therefore, the controller 170 may control the personalized zoom video icon 601 not to be displayed on the display unit 180, if the movement of the pointer (not shown) is not detected for a preset period of time or more. The controller 170 may control the personalized zoom video icon 601 to be displayed on the display unit 180 as the movement of the pointer (not shown) is detected.

The shape, position, and the like of the personalized zoom video icon 601 shown in FIG. 6 are merely illustrative, and therefore, it is apparent that the present invention is not limited thereto.

The controller 170 may control a personalized zoom video to be stored as a command for selecting the personalized zoom video icon 601 is received.

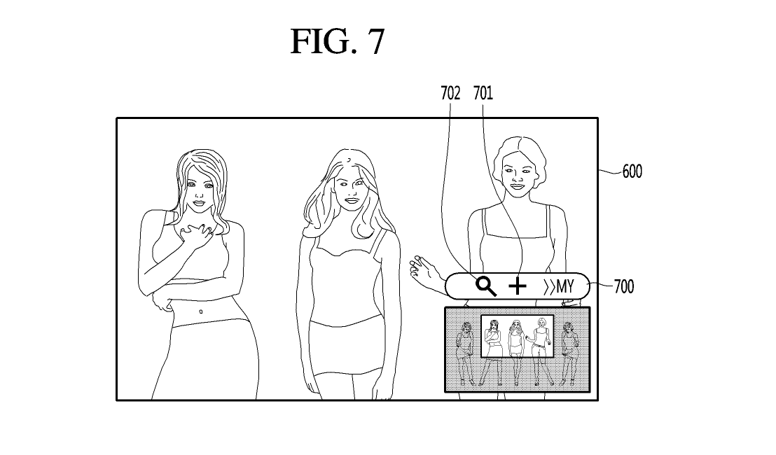

FIG. 7 is a view illustrating a personalized zoom video item according to an embodiment of the present invention.

As shown in FIG. 7, the controller 170 may control a personalized zoom video item 700 to be displayed as the command for selecting the personalized zoom video icon 601 is received.

The personalized zoom video item 700 may be a form in which the personalized zoom video icon 601 extends. Alternatively, the controller 170 does not include the personalized zoom video icon 601, and may control the personalized zoom video item 700 to be always displayed on the display unit 180.

The personalized zoom video item 700 may include a personalized zoom video addition icon 701 and a personalized zoom video loading icon 702. In FIG. 7, a case where one personalized zoom video is stored in the storage unit 140 has been described as an example. Thus, the personalized zoom video item 700 includes one personalized zoom video loading icon 702. When a plurality of personalized zoom videos are stored in the storage unit 140, the personalized zoom video item 700 may include a plurality of personalized zoom video loading icons 702.

The controller 170 may control a personalized zoom video to be stored as a command for selecting the personalized zoom video addition icon 701 is received. That is, the controller 170 may recognize the personalized zoom video addition icon 701 as a personalized zoom video storage command.

Alternatively, according to another embodiment of the present invention, the controller 170 may receive a command for storing a personalized zoom video through a button (not shown) provided in the remote control device 200.

According to another embodiment, the controller 170 may receive a command for storing a personalized zoom video through a button (not shown) provided in the display device 100.

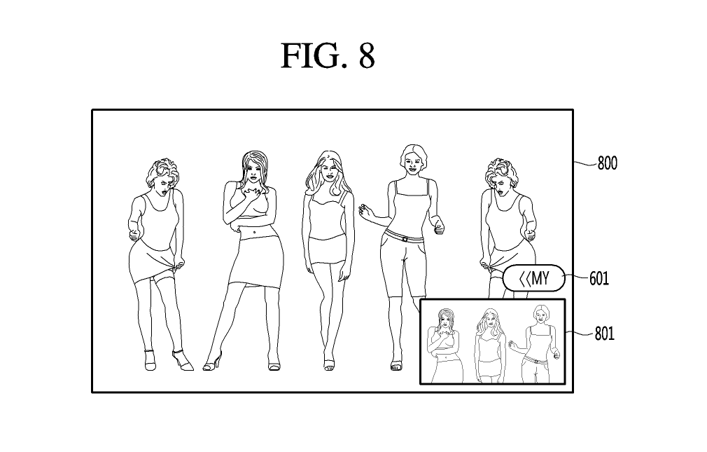

In addition, as shown in FIG. 8, the controller 170 may receive the personalized zoom video storage command even when a main screen 800 and a sub-screen 801 are shifted from each other.

FIG. 8 is a view illustrating an operation of receiving the personalized zoom video storage command according to an embodiment of the present invention.

Specifically, when the zoom control command is received, the controller 170 may control the display unit 180 to display a zoomed video on the main screen 800 and to display the entire video on the sub-screen 801 as shown in FIG. 6 or 7.

Alternatively, when the zoom control command is received, the controller 170 may control the display unit 180 to display the entire video on the main screen 800 and to display a zoomed video on the sub-screen 801, unlike as shown in FIG. 6 or 7.

Alternatively, the controller 170 may control the display unit 180 to display the entire video on the main screen 800 and to display a zoomed video on the sub-screen 801 as a command for selecting a main/sub-screen shift icon (not shown) is received in the video as shown in FIG. 6 or 7.

As described above, when the zoom control command is received, the display unit 180 can display zoomed videos and the entire video in various forms.

The controller 170 may control a personalized zoom video to be stored, if the personalized zoom video storage command is received regardless of which video is to be displayed in each of the main screen 800 and the sub-screen 801.

That is, like as described with reference to FIGS. 6 and 7, the personalized zoom video storage command may be received through the personalized zoom video icon 601 or the personalized zoom video addition icon 701 even when the entire video is displayed on the main screen 800 and the zoomed video is displayed on the sub-screen 801 as shown in FIG. 8. In this case, the controller 170 may store a video such that the video displayed on the sub-screen 801 is played when a command for storing a subsequently stored personalized zoom video is received.

Again, FIG. 5 is described.

If the command for storing the personalized zoom video is not received (S103), the controller 170 may control the video to be continuously displayed on the display unit 180 (S101).

If the command for storing the personalized zoom video is received (S103), the controller 170 may control zoom data of a video based on at least one of a pointer position coordinate and a zoom level to be stored in the storage unit 140 (S105).

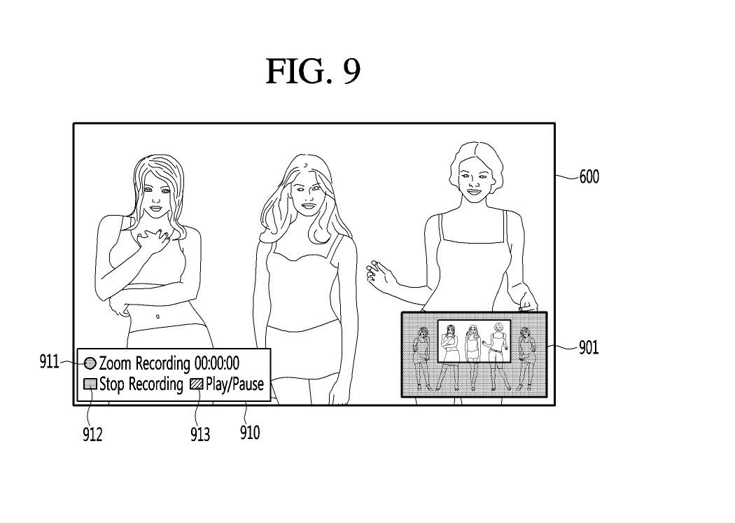

Next, a screen displayed on the display unit 180 during storage of a personalized zoom video will be described with reference to FIG. 9.

FIG. 9 is a view illustrating a screen displayed on the display unit during storage of a personalized zoom video according to an embodiment of the present invention.

The controller 170 may control a personalized zoom video storage guide 910 to be displayed on the display unit 810 during storage of a personalized zoom video.

The controller 170 may inform, through the personalized zoom video storage guide 910, a user that the storage of the personalized zoom video is in progress. The user may recognize, through the personalized zoom video storage guide 910, that the current personalized zoom video is being stored. Thus, the user can recognize that, if the position and magnification of a video is manipulated while the personalized zoom video storage guide 910 is being displayed, a manipulation history will be stored.

The personalized zoom video storage guide 910 may include a time 911 at which the personalized zoom video is being stored, a personalized zoom video storage end icon 912, and a play/pause icon 913 of the video.

The controller 170 control the zoom data based on the at least one of the pointer position coordinate and the zoom level to be stored in the storage unit 140 whenever the zoom control command is performed while the storage of the personalized zoom video is being performed. A detailed description of the zoom data will be described later.

Also, the controller 170 may also control the zoom data to be stored in the storage unit 140 when the zoom control command is received not only during playing of the video but also in a state in which the video is paused while the storage of the personalized zoom video is being performed.

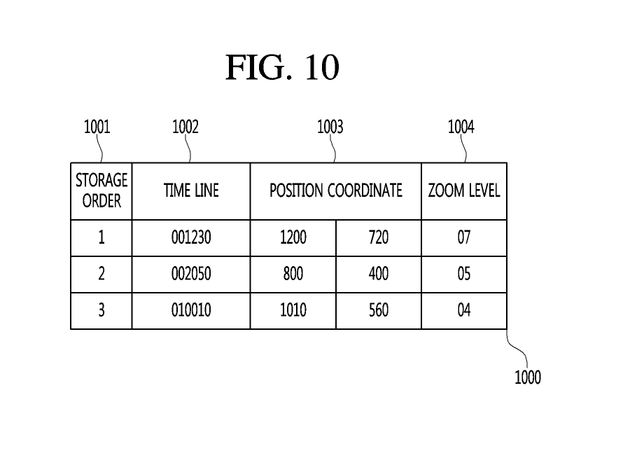

Next, zoom data according to an embodiment of the present invention will be described with reference to FIG. 10.

FIG. 10 is a view illustrating an example of zoom data according to an embodiment of the present invention.

The zoom data may refer to data in which pointer position coordinates, zoom levels, and the like when the zoom control is performed on a video are stored in a text format. The zoom data may be included in meta data of the video.

Since the zoom data is stored in the text format, it is possible to reduce the size of a space occupying the storage unit 140. That is, when a user produces a video for only the user, on which is enlarged and shifted through the live zoom function, if the produced video is separately stored, the capacity of the video may be very large. However, in the present invention, when a user produces a video for only the user using the method in which zoom data is stored in the text format, thereby simultaneously processing the original video and the zoom data, it is possible to considerably reduce the capacity of the video.

As shown in FIG. 10, according to the embodiment of the present disclosure, the zoom data 1000 may include at least one of a storage order, a time line, a pointer position coordinate, and a zoom level 1004.

A storage order 1001 may refer to an order in which zoom data of a video are stored as a command for storing a personalized zoom video is received. Specifically, the controller 170 may control zoom data of the video to be stored in the storage unit 140 whenever the zoom control command is received during storage of the personalized zoom video. That is, the controller 170 may control zoom data of the video to be stored in the storage unit 140 whenever the zoom control is performed on the video during the storage of the personalized zoom video. Therefore, the storage order 1001 may refer to an order in which zoom data of the video are stored from after the command for storing the personalized zoom video is received.

A time line 1002 may represent a play time of a video at a point of time when the zoom data 1000 is stored. That is, the time line 1002 may represent a play time of a video at the moment when the zoom control is performed on the displayed video. According to the embodiment shown in FIG. 10, the time line 1002 of first zoom data is 001230, the time line 1002 of second zoom data is 002050, and the time line 1002 of third zoom data is 010010. This may mean that the zoom control has been performed on the first zoom data at a play time of the video, i.e., 00:12:30, the zoom control has been performed on the second zoom data at a play time of the video, i.e., 00:20:50, and the zoom control has been performed on the third zoom data at a play time of the video, i.e., 01:00:10.

A pointer position coordinate 1003 may refer to pointing coordinate information at a point of time when the zoom control is performed.

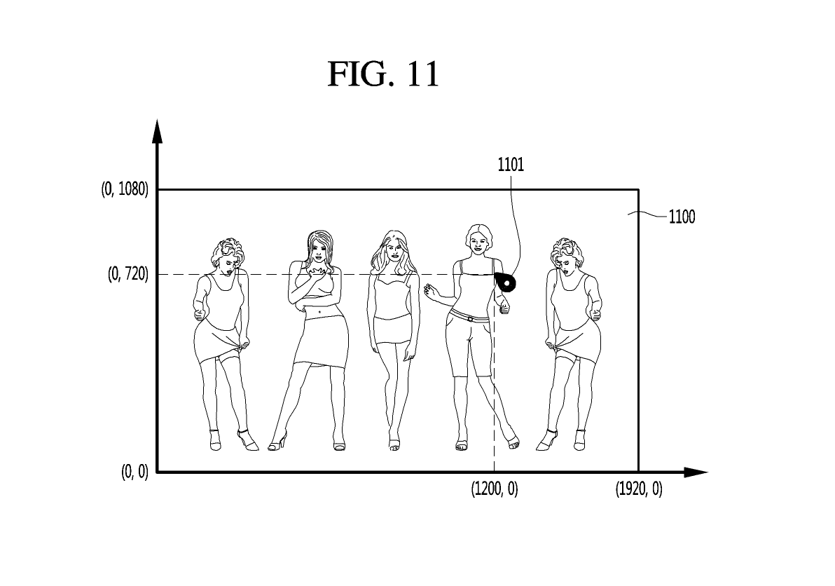

Next, a pointer position coordinate according to an embodiment of the present invention will be described with reference to FIG. 11.

FIG. 11 is an exemplary view illustrating a pointer position coordinate when the zoom control command is received using a pointer according to an embodiment of the present invention.

As shown in an example of FIG. 11, the controller 170 may receive a command for selecting a specific position of a video 1100 using a pointer 1101 so as to zoom in a specific point of the video 1100.

The pointer position coordinate 1003 may refer to coordinate information representing a specific position of a video selected using the pointer 1101 so as to perform the zoom control as described above. In the example shown in FIG. 11, the controller 170 may store, in the storage unit 140, 1200 and 720, which are selected using the pointer 1101, as the point position coordinate 1003 of zoom data. Specifically, the controller 170 may store, as the pointer position coordinate 1003 of the zoom data, x and y coordinates of the video 1100 selected using the pointer 1101 when the zoom control command is performed.

Similarly, the controller 170 may control x and y coordinates of a video on which the zoom control command is performed to be stored as the pointer position coordinate 1003 of zoom data even when the zoom control command is received with respect to a sub-screen.

Again, FIG. 10 is described.

The zoom data 100 may include a zoom level 1004. The zoom level 1004 may refer to information on a magnification where the zoom control is performed on a video. That is, the zoom level 1004 may include a magnification where the video is enlarged or reduced. For example, that the zoom level 1004 is 1 may represent an original video having ×1 magnification, on which a zoom-in or zoom-out operation is not performed. In addition, it may be controlled that, as the zoom level 1004 is increased by 1, the magnification of the original video is increased by 0.1. Specifically, that the zoom level 1004 is 1 may represent an original video (×1), that zoom level 1004 is 2 may represent that the original video is enlarged with ×1.1 magnification, that the zoom level 1004 is 3 may represent that the original video is enlarged with ×1.2 magnification, and that the zoom level 1004 is 7 may represent that the original video is enlarged with ×1.6 magnification.

According to an embodiment of the present invention, the zoom level 1004 may be controlled through a button provided in the remote control device 200. According to another embodiment of the present invention, the zoom level 1004 may be controlled through a wheel provided in the remote control device 200. For example, if a command for pushing the wheel forward, the controller 170 may control an enlargement magnification to be increased. If a command for pushing the wheel backward, the controller 170 may control the enlargement magnification to be decreased.

The zoom data will be described in detail with reference to the example shown in FIG. 10. The first zoom data is 01_001230_1200_720_7, the second zoom data is 02_002050_800_400_05, and the third zoom data is 03_010010_1010_560_04. This means that a video is enlarged with ×1.6 magnification at position (1200, 720) at play time 00:12:30, a video is enlarged with ×1.4 magnification at position (800, 400) at play time 00:20:50, and a video is enlarged with ×1.3 magnification at position (1010, 560) at play time 01:00:10.

According to another embodiment of the present invention, the zoom data 1000 may further include a thumbnail image (not shown). The storage unit 140 may store a thumbnail image corresponding to a video on which the zoom control is performed when the zoom control command is received. When the zoom control command is received, the controller 170 may control a video at the moment when its zoom is changed to be stored as a thumbnail image of each zoom data in the storage unit 140.

The controller 170 may store an image itself as a thumbnail image of the zoom data 1000. Alternatively, the controller 170 may store a storage position of the image as a thumbnail image of the zoom data 1000.

According to another embodiment of the present invention, the zoom data 1000 may further include at least one of a content classification category, a time stamp, and an object tag information, in addition to the storage order, the time line, the pointer position coordinate, and the zoom level.

The content classification category may refer to a record classification tag. That is, the content classification category may be a tag for determining to which one the genre of a content corresponds among sport, movie, documentary, drama, show, and the like.

The time stamp may represent a time at a point of time when one point of a video displayed on the display unit 180 is specified using the pointer. That is, the time stamp may represent when zoom data was stored. For example, if the time stamp stored in the storage unit 140 is 20130531183610, it is represented that corresponding zoom data was stored at 18 o'clock 36 minutes 10 seconds, May 31, 2016.

The object tag information may refer to information on corresponding object tags when a specific object is selected using the pointer. For example, the object tags may be OBJ1, OBJ2, and OBJ3. Alternatively, object tags may be included in a video. For example, the genre of a content is the sport, object tags such as Jisung Park, Rooney, and Ronaldo may be included in the video.

Again, FIG. 5 is described.

The controller 170 may receive a zoom control command (S107).

That is, the controller 170 may receive the zoom control command during the storage of the personalized zoom video.

The zoom control command may include a magnification change command and a position change command. The magnification change command may be received through a command for selecting how a zoom-in or zoom-out operation is to be performed.

The degree of the zoom-in or zoom-out operation may be controlled through a zoom scroll bar (not shown) displayed on the display unit 180. The position change command may be received through a command for selecting, using the pointer, a position of a video on which the zoom-in or zoom-out operation is to be performed.

The controller 170 may change the zoom of the video displayed on the display unit 180 according to the received zoom control command (S109).

The controller 170 may display the video of which zoom is changed on the display unit 180, based on the received zoom control command.

Also, the controller 170 may accumulate and store, in the storage unit 140, zoom data corresponding to the received zoom control command (S111).

The controller 170 may store zoom data in the storage unit 140 whenever the zoom control command is received.

That is, as described in FIG. 10, the controller 170 controls zoom data to be accumulated and stored in the storage unit 140 in an order of the first zoom data, the second zoom data, and the third zoom data whenever the zoom control command is received.

The operation of accumulating and storing the zoom data may be ended as a personalized zoom video storage operation is completed. That is, the controller 170 controls zoom data to be accumulated and stored in the storage unit 140 during the personalized zoom video storage operation. If the personalized zoom video storage operation is completed and then re-started, the controller 170 controls new zoom data to be stored in the storage unit 140.

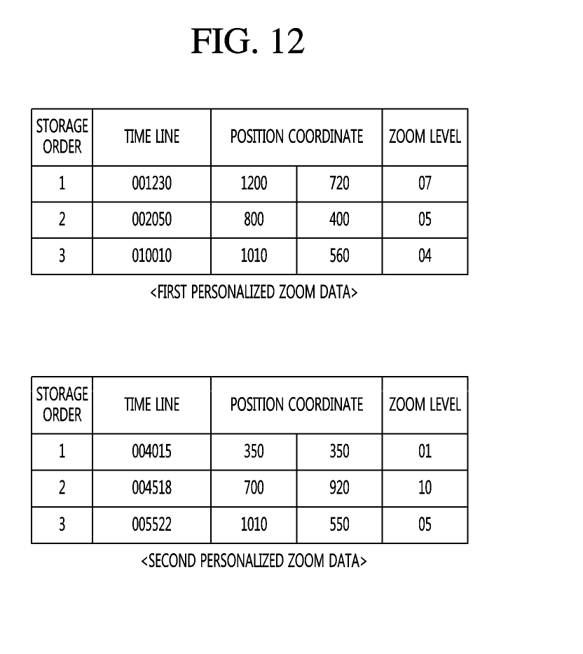

An example will be described in detail with reference to FIG. 12.

FIG. 12 is a view illustrating a method for storing zoom data in the storage unit according to an embodiment of the present invention.

The controller 170 may store, in the storage unit 140, first zoom data 01_001230_1200_720_7, second zoom data 02_002050_800_400_05, and third zoom data 03_010010_1010_560_04 while a primary personalized zoom video storage operation is being performed. Also, as a command for performing a new secondary personalized zoom video storage operation is received after the primary personalized zoom video storage operation is completed, the controller 170 may store, in the storage unit 140, first zoom data 01_004015_350_350_1, second zoom data 02_004518_700_920_10, and third zoom data 03_005522_1000_5500_05. The storage unit 140 may manage, as first personalized zoom data, zoom data corresponding to the primary personalized zoom video storage operation, and may manage, as second personalized zoom data, zoom data corresponding to the secondary personalized zoom video storage operation.

That is, in the case of the same video, the video may be differently played depending on whether the video is processed as the first personalized zoom data or the second personalized zoom data.

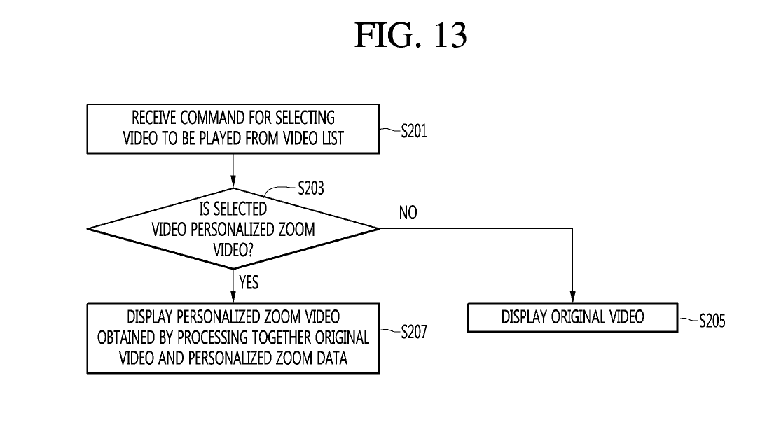

Next, an operation of playing a personalized zoom video according to an embodiment of the present invention will be described with reference to FIG. 13.

FIG. 13 is a flowchart illustrating a method for loading a personalized zoom video according to an embodiment of the present invention.

The controller 170 may receive a command for selecting a video to be played from a video list (S201).

The controller 170 may receive a command for selecting a general video or a personalized zoom video stored in the storage unit 140.

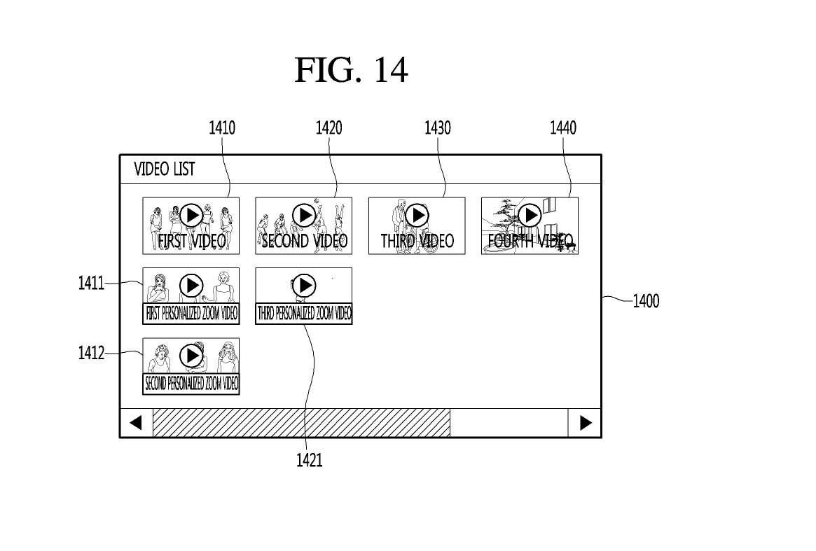

Next, an operation of receiving a command for selecting a video to be played from a video list will be described with reference to FIG. 14.

FIG. 14 is a view illustrating a video list using thumbnail images according to an embodiment of the present invention.

The display unit 180 may display a video list 1400 thereon. The video list 1400 may include general videos 1410, 1420, 1430, and 1440 and personalized zoom videos 1411, 1412, and 1421.

Here, each of the general videos 1410, 1420, 1430, and 1440 may refer to an original video in which zoom data is not stored. Alternatively, each of the general videos 1410, 1420, 1430, and 1440 may refer to a video that is played without reflecting zoom data stored therein.

Each of the personalized zoom videos 1411, 1412, and 1421 may refer to a video that is played by processing together a general video and zoom data. For example, if a command for selecting a first personalized zoom video 1411 is received, the controller 170 may control the first personalized zoom video 1411 to be played by processing together a first video 1410 and first personalized zoom data. Similarly, if a command for selecting a second personalized zoom video 1412 is received, the controller 170 may control the second personalized zoom video 1412 to be played by processing together the first video 1410 and second personalized zoom data. Therefore, the first video 1410, the first personalized zoom video 1411, and the second personalized zoom video 1412 are videos identical to one another. However, the first video 1410, the first personalized zoom video 1411, and the second personalized zoom video 1412 are videos that are played with different magnifications at different positions, respectively. A third personalized zoom video 1421 may be a video that is played by processing together a second video 1420 and separate personalized zoom data.

That one video and zoom data are processed together is similar to that a subtitle file is processed in the one video. Specifically, that one video and zoom data are processed together may mean that the one video is played as a magnification change and a position change are applied to the one video at each play time stored in the zoom data.

As a command for selecting any one video from the displayed video list 1400 is received, the controller 170 may display a video corresponding to the position of the selected video. For example, the controller 170 may receive a command for selecting any one of thumbnail images respectively representing the personalized zoom videos 1411, 1412, and 1421. In this case, the controller 170 may display a video obtained by processing together an original video and zoom data corresponding to the selected thumbnail image.

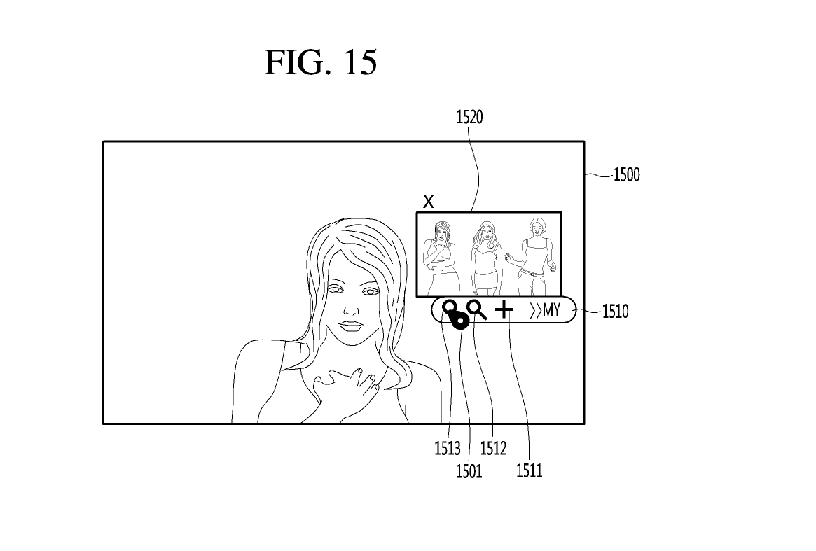

Next, an operation of loading a personalized zoom video related to a video being played according to an embodiment of the present invention will be described with reference to FIG. 15.

FIG. 15 is a view illustrating a method for loading a personalized zoom video related to a video being played according to an embodiment of the present invention.

As shown in FIG. 15, the display unit 180 may display a video 1500 thereon. The video 1500 may be a general video that is not processed together with zoom data. Alternatively, the video 1500 may be a personalized zoom video that is processed together with zoom data.

The controller 170 may receive a command for selecting a personalized zoom video icon while the video 1500 is being displayed on the display unit 180. As the command for selecting the personalized zoom video icon is received, the controller 170 may display a personalized zoom video item 1510 on the display unit 180.

The personalized zoom video item 1510 may include a personalized zoom video addition icon and at least one personalized zoom video loading icon.

For example, as shown in FIG. 15, the personalized zoom video item 1510 may include a personalized zoom video addition icon 1511, a first personalized zoom video loading icon 1512, and a second personalized zoom video loading icon 1513.

The controller 170 may detect that a pointer 1501 is located on any one of the first personalized zoom video loading icon 1512 and the second personalized zoom video loading icon 1513. If it is detected that the pointer 1501 is located on a personalized zoom video loading icon, the controller 170 may display a thumbnail image corresponding to the corresponding personalized zoom video loading icon. For example, if it is detected that the pointer 1501 is located on the second personalized zoom video loading icon 1513, the controller 170 may display a thumbnail image 1520 of a personalized zoom video corresponding to the second personalized zoom video loading icon 1513.

A user can view thumbnail images of personalized zoom videos respectively corresponding to the personalized zoom video loading icons 1512 and 1513 by moving the pointer 1501.

As described above, the user can identify personalized zoom videos stored with respect to a currently viewing video through the personalized zoom video item. Particularly, the user can specifically identify which video is a personalized zoom video that the user desires to view by viewing thumbnail images of the respective personalized zoom videos.

The thumbnail image(s) shown in FIG. 14 or 15 may include a thumbnail image stored in the zoom data 1000. Particularly, when a plurality of thumbnail images are included in the zoom data 1000, the firstly stored thumbnail image may be a representative thumbnail image. Alternatively, a command for selecting one of the plurality of thumbnail images as the representative thumbnail image may be received from the user. When a plurality of thumbnail images are included in the zoom data 1000 as described above, the representative thumbnail image may be displayed in the video list 1400, or may be displayed as the thumbnail image 1520.

The personalized zoom videos that can be viewed through the personalized zoom video item may be videos directly stored by the user.

Alternatively, the personalized zoom videos that can be viewed through the personalized zoom video item may be personalized zoom videos stored by other users. That is, although the user does not directly store personalized zoom videos, personalized zoom videos stored by other users may be loaded from an external server.

Alternatively, the personalized zoom videos that can be viewed through the personalized zoom video item may be personalized zoom videos directly stored by a producer of a current played video. That is, the producer of the video can also provide an original video and personalized zoom videos obtained by processing together the original video and zoom data.

Again, FIG. 13 is described.

The controller 170 may determine whether the selected video is a personalized zoom video (S203). That is, the controller 170 may acquire whether the selected video is a personalized zoom video.

When the selected video is not the personalized zoom video, the controller 170 may display an original video (S205).

The original video may refer to a video on which no magnification change and no position change are performed as no personalized zoom data is stored in the video.

Alternatively, the original video may refer to a video on which no magnification change and no position change are performed as personalized zoom data is stored in the video but is not processed together with the video.

When the selected video is the personalized zoom video, the controller 170 may display the personalized zoom video obtained by processing together the original video and personalized zoom data (S207).

The personalized zoom video may refer to a video obtained by processing together an original video and personalized zoom data.

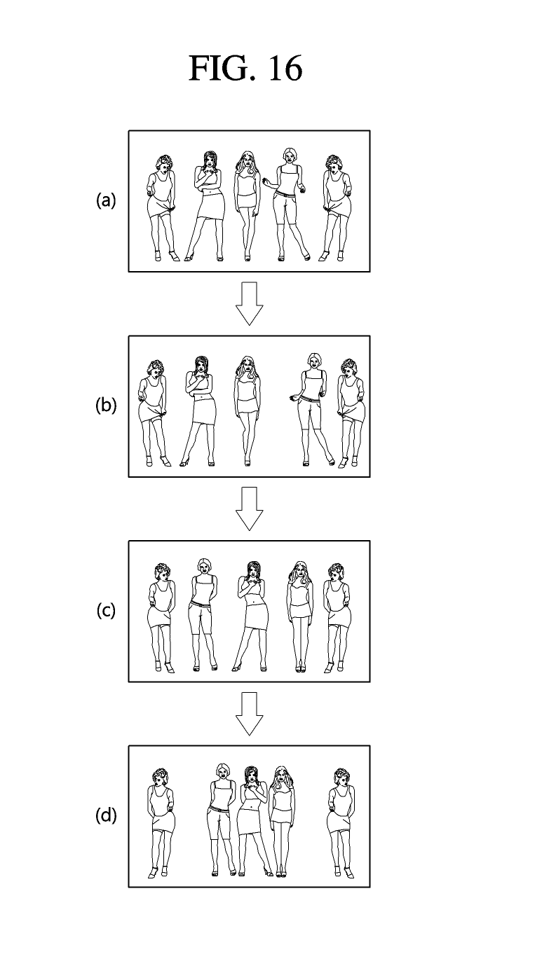

Next, an operation of displaying an original video and personalized zoom videos according to embodiments of the present invention will be described with reference to FIGS. 16 to 18.

FIG. 16 is a view illustrating an original video displayed on the display unit according to an embodiment of the present invention.

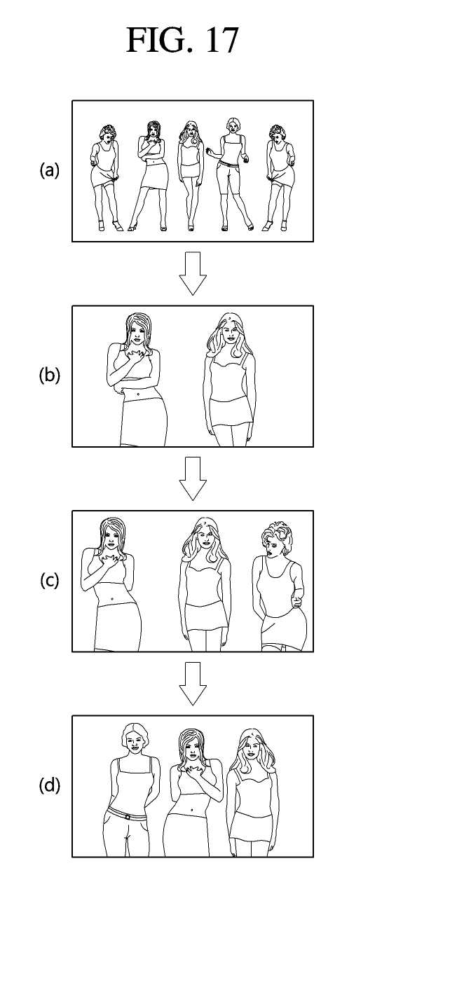

FIG. 17 is a view illustrating a personalized zoom video displayed on the display unit according to a first embodiment of the present invention.

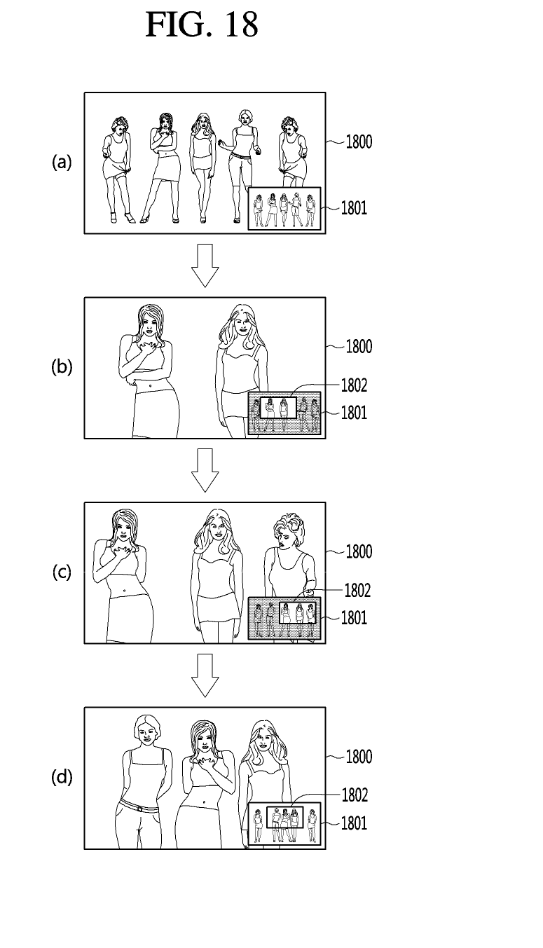

FIG. 18 is a view illustrating a personalized zoom video displayed on the display unit according to a second embodiment of the present invention.

Here, the personalized zoom videos of FIGS. 17 and 18 may correspond to videos displayed by processing together the original video shown in FIG. 16 and first personalized zoom data and second personalized zoom data.

FIGS. 16 to 18 are views illustrating how the original video according to the embodiment of the present invention, the personalized zoom video according to the first embodiment, and the personalized zoom video according to the second embodiment are displayed as time elapses. That is, referring to FIG. 16, the original video may be displayed in an order of FIGS. 16(a), 16(b), 16(c), and 16(d). Similarly, the personalized zoom video according to the first embodiment may be displayed in an order of FIGS. 17(a), 17(b), 17(c), 17(d). The personalized zoom video according to the second embodiment may be displayed in an order of FIGS. 18(a), 18(b), 18(c), and 18(d).

Here, video play times of FIGS. 16(a), 17(a), and 18(a) are the same. Similarly, video play times of FIGS. 16(b), 17(b), and 18(b) are the same, video play times of FIGS. 16(c), 17(c), and 18(c) are the same, and video play times of FIGS. 16(d), 17(d), and 18(d) are the same.

That is, for example, if a scene of FIG. 16(b) is displayed at 13:50 when the original video is played, a scene of FIG. 17(b) may be displayed at 13:50 when the personalized zoom video according to the first embodiment is played, and a scene of FIG. 18(b) may be displayed at 13:50 when the personalized zoom video according to the second embodiment is played.

Specifically, when the original video is displayed on the display unit 180 according to the embodiment of the present invention, the entire video on which no position change and no enlargement change are performed is displayed in the order as shown in FIG. 16. However, when the personalized zoom video is displayed on the display unit 180 according to the first embodiment of the present invention, a video obtained by processing together the original video and personalized zoom data is displayed. That is, a video obtained by performing a magnification change and an enlargement change on the video of FIG. 16 according to information on the personalized zoom data may be displayed as shown in FIG. 17. Therefore, only a specific portion may be enlarged and displayed from the video shown in FIG. 16.

Next, a case where the personalized zoom video is displayed on the display unit 180 according to the second embodiment of the present invention will be described. The personalized zoom video according to the second embodiment is similar to the personalized zoom video shown in FIG. 17, but a sub-screen 1801 may be further displayed.

The sub-screen 1801 may be a screen for displaying how each scene has been obtained by performing a position change and a magnification change on the original video. Also, the sub-screen 1801 may be a screen for displaying which portion the personalized zoom video is as compared with the entire video.

When no position change and no magnification change are performed, the sub-screen 1801 may not be displayed on the display unit 1801. Alternatively, when no position change and no magnification change are performed, the sub-screen 1801 may display the entire screen thereon.

When a position change and a magnification change are performed, the sub-screen 1801 may display the other portions except a portion displayed on the entire screen 1800 to be dark.

Alternatively, as shown in FIG. 18(d), the sub-screen 1801 may display, as a box 1802, only a portion displayed on the entire screen 1800. However, this is merely illustrative, and therefore, it is apparent that the present invention is not limited thereto.

According to an embodiment of the present invention, the above-described method can be embodied in storage media in which programs are recorded as codes that a processor can read. The media that the processor can read, include ROMs, RAMS, CD-ROMs, magnetic tape, floppy discs, optic data storage devices, etc., and also, include things embodied in the form of carrier wave (e.g., transmission through the internet).

The above-described display device is not limited to the configurations and methods of the above-described embodiments, but all or some of the respective embodiments may be selectively combined and executed so that various modifications can be made.

According to the present invention, in the case of the same video, a portion to be enlarged in the video can be controlled for every user, thereby producing a video for only a user.

According to the present invention, it is possible to prevent an inconvenience in that, when the same video is viewed, an enlargement magnification change and a position change should be repeated through the live zoom function.

According to the present invention, a live zoom manipulation history can be stored as a file in a text format, thereby reducing the size of a video for only a user when the video is produced.

According to the present invention, as a live zoom manipulation history is received from a server, the same video can be viewed in various versions, thereby providing interest to users.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A display device comprising:
a display unit configured to display a first video;
a controller configured to receive a zoom control command for the first video and control a second video on which zoom control is performed to be displayed on the display unit according to the received zoom control command; and
a storage unit configured to store zoom data on the basis of the received zoom control command and a thumbnail image corresponding to the second video,
wherein, as a command for selecting the thumbnail image corresponding to the second video is received, the controller controls the second video to be displayed by processing together the first video and the zoom data.

2. The display device according to claim 1, wherein the zoom control command comprises a magnification change command of a video and a position change command of the video.

3. The display device according to claim 1, wherein the zoom data comprises a play time of the video on which the zoom control is performed according to the zoom control command, a pointer position coordinate, and magnification information.

4. The display device according to claim 3, wherein the zoom data further comprises a storage position of the thumbnail image, and
the thumbnail image comprises an image at the moment when the zoom control is performed on the video according to the zoom control command.

5. The display device according to claim 3, wherein the zoom data is data stored in a text format.

6. The display device according to claim 1, wherein, when a zoom video storage command is received, the storage unit stores the zoom data on the basis of the received zoom control command and the thumbnail image corresponding to the second video.

7. The display device according to claim 6, wherein the controller recognizes the received zoom control command as the zoom video storage command.

8. The display device according to claim 6, wherein the storage unit accumulates and stores the zoom data on the basis of the zoom control command whenever the zoom control command is received.

9. The display device according to claim 1, wherein the display unit displays a video list comprising a first video list and a second video list.

10. The display device according to claim 9, wherein the controller controls an original video on which the zoom control is not performed to be displayed on the display unit if a command for selecting the first video list is received, and controls the second video to be displayed on the display unit by processing together the first video and the zoom data if a command for selecting the second video list is received.

11. The display device according to claim 9, wherein the second video list comprises a thumbnail image at the moment when the zoom control is performed as the zoom control command is received.

12. The display device according to claim 10, wherein the display unit further displays a sub-screen when the second video is displayed, and
the sub-screen is a screen for displaying which portion the second video in the first video.

13. The display device according to claim 1, wherein the display unit further displays a list of at least one zoom video related to the first video while the first video is being displayed.

14. The display device according to claim 13, wherein the at least one zoom video related to the first video comprises videos played by processing together the first video and previously stored zoom data.

15. The display device according to claim 13, wherein the at least one zoom video related to the first video comprises videos played by processing together the first video and zoom data received from an external server.
